(19) United States
(12) Patent Application Publication
(10) Pub. No.: US 2018/0227850 A1
(43) Pub. Date: Aug. 9, 2018

(54) COMMUNICATIONS PROTOCOL FOR INVENTORY CONTROL

(71) Applicants: CHRISTIE LITES ENTERPRISES CANADA, INC., TORONTO (CA); GBX TECHNOLOGY LLC, SUNRISE, FL (US)

(72) Inventor: GIANCARLO BREGANTE, SUNRISE, FL (US)

(73) Assignees: CHRISTIE LITES ENTERPRISES CANADA, INC., TORONTO (CA); GBX TECHNOLOGY LLC, SUNRISE, FL (US)

(21) Appl. No.: 15/427,752

(22) Filed: Feb. 8, 2017

(51) Int. Cl. H04W 52/02; H04W 76/04; H04B 5/00; G06K 19/07; G06K 19/077; G06K 7/10; G06Q 10/08

(52) U.S. Cl. CPC H04W 52/0229; H04W 76/046; H04B 5/0062; G06Q 10/087; G06K 19/07758; G06K 7/10158; G06K 19/0702

(57) ABSTRACT

Inventory tracking systems and methods are provided herein that utilize a communication protocol that provides randomized parameters to ensure transmission between one or more remote devices and a central device. Remote devices enter a sleep mode for a randomized sleep period, and then enter a power-on mode after the period of sleep time has elapsed. When in the power-on mode, the remote device listens and identifies whether a beacon message is sent from the central device. If a beacon message is detected, the remote device sends a return message and then returns to sleep mode. If a beacon message is not detected, the remote device returns to sleep mode.

### FIELD OF THE INVENTION

The present invention generally relates to a wireless communications protocol. More specifically, the present invention comprises systems and methods for a communication protocol that utilizes randomized parameters to ensure transmission between one or more remote devices and a central device.

### BACKGROUND OF THE INVENTION

Inventory of all types may be stored in large quantities within a warehouse or other containment area. Inventory generally consists of items such as raw materials, works in progress, or finished goods that are stored and meant to be either rented or sold at some time in the near future.

With large quantities of inventory stored, a need arises to correctly track each item. Radio-frequency identification (RFID) is a known system that utilizes an electromagnetic field to automatically identify and track tags attached to inventory items. However, RFID systems run into problems when there are many inventory items and, therefore, many tags. This is especially so when the items are also located in a small area.

More specifically, RFID systems require that data be transferred across specific frequencies of the electromagnetic spectrum between tags placed on inventory items and a central device or hub. When many tags are present, there is a likelihood that packet collisions occur as multiple tags attempt to send packetized data to the central device simultaneously. This problem occurs when the central device attempts to read a large number of inventory tags at the same time and on the same frequency, and is exacerbated when tags are centralized in a small area. When packet collisions occur, data from the tagged inventory item is not received by the central device and the data must be resent or the data loss results in incorrect inventory tracking.

Further, RFID tags generally employ batteries, which allow the range of the system in which they are employed to be increased. Unfortunately, repeated attempts by tags to send data to central device may quickly wear down these batteries, especially if data must be resent multiple times due to the occurrence of tag collisions. Battery life is also quickly drained if the inventory tags are constantly powered on, listening for a signal from the central hub, and waiting to respond.

### BRIEF DESCRIPTION OF THE DRAWINGS

The following drawings illustrate examples of various components of the invention disclosed herein, and are for illustrative purposes only. Other embodiments that are substantially similar can use other components that have a difference appearance.

FIG. 1 is a schematic diagram of an embodiment of the present invention.

FIG. 2 is a data transmission timing diagram corresponding to an embodiment of the present invention.

FIG. 2A is schematic diagram of an embodiment of the present invention.

FIG. 3 is a schematic diagram of the circuitry for a central device.

FIG. 4 is a schematic diagram of the circuitry for a remote device.

FIG. 5 is an illustration of a transmission sequence for a remote device.

FIG. 6 is an illustration of the structure of a packet for a beacon signal.

FIG. 7 is an illustration of the structure of a packet for a remote device ID.

FIG. 8 is an illustration of a beacon broadcasting structure.

FIG. 9 is an illustration of a remote device broadcasting structure.

FIG. 10 is a schematic diagram of a system employing one central device and multiple remote devices.

FIG. 11 is a schematic diagram of a system employing multiple central devices and multiple remote devices.

FIG. 12 is a flowchart of a method of the present invention.

FIG. 13 is a flowchart of a method of the present invention.

FIG. 13A is a flowchart of a method of the present invention.

FIGS. 14A-E illustrate a screen shot of a simulator that may be used to define parameters for the present invention.

FIG. 15 is a graph depicting packet collision rate results for certain system parameters for an example system in line with the present invention.

### DETAILED DESCRIPTION

There is therefore provided an inventory tracking method and system which allows periodic transmission between remote devices and central devices to take place at random points in time. By randomizing when a device transmits, collisions amongst device transmissions that take place when multiple devices transmit on the same frequency at the same time. The present invention relates to a wireless communication protocol that allows for communication between remote devices (hereinafter referred to as Tags) and central devices (hereinafter Gateways).

Because of the nature of the wireless communication protocol of the present invention, Tags may be simple remote devices that are easily and inexpensively manufactured. The Tags of the present invention require minimal memory and processing power, which are factors that further extend the battery life of the devices.

The Tags are not required to be constantly “awake” and listening for messages from the Gateway to respond to. If the Tags are programmed to only wake up and listen at certain intervals, the battery life of the Tags may be improved.

Tags may be attached to items to be tracked to determine whether the items are proximate a Gateway. When Tags are proximate at least one Gateway, the periodic transmissions between Tags and Gateway allow the system to know that a tag is in the vicinity. When a period of time has elapsed and a particular Tag has not communicated with a Gateway, then the system knows that the Tag is no longer in the vicinity. In this way, Tags may be used to keep track of items. The system will be described in greater detail below.

The communication protocol of the present invention is intended to allow the guaranteed transmission of a data payload sent by a plurality of Tags during a certain time period. The communication protocol allows data packets, comprising, amongst other information, Tag identification information to be sent from Tags to Gateways more efficiently while avoiding time consuming steps, such as handshakes that require an exchange of information via transmissions between Tags and Gateways. The communication protocol enables energy savings at any given Tag during the transmission process while also sending the payload from Tags to Gateways as often as possible in order to update the Tags' status. Energy is saved as the number of transmissions of a payload required to guarantee that transmission has been received by a Gateway is minimized.

The data payload sent by a particular Tag is made up of one or more data packets. The payload can be received at the same time by one or more Gateways, depending on how the overall system's topology and configuration are implemented at a specific site (e.g. at a warehouse). In one embodiment, data packets received by the Gateways may be collectively sent to an Inventory Server where they may be filtered (for example, by eliminating duplicate or repeated data packets received from the same Tag) and processed to properly update the inventory system. The Inventory Server uses this information to track when the last time a Tag communicated with a Gateway. In one embodiment, when a predetermined period of time has passed and no Gateway in the system has received a communication from the Gateway, the Tag may be marked on the Inventory Server as being away or absent. The person skilled in the art will appreciate that when the Tags are attached to inventory items to be tracked within a warehouse, the presence or absence of an inventory item may be tracked by checking the last time the Tag communicated with a Gateway. The system may be configured such that there is a predetermined time period in which all tags are guaranteed to have communicated with the Gateway at least once. If the predetermined timed period has elapsed and a Tag has not communicated with a Gateway, then the Tag is no longer proximate to any of the Gateways in the system.

In one embodiment, the communication protocol is unidirectional in the sense that information is broadcast from the Gateway to the Tags, and from the Tags back to the Gateway with no requirement for handshaking or request/response communication between Tags and Gateways. More specifically, there is no need for a receiving device to confirm receipt of a signal transmitted by a sending device by responding to that signal as all communications have a 100% transmission success rate. In an embodiment, the Gateway broadcasts a beacon signal to the Tags and, in response, the Tags broadcast data packets to the Gateway. The beacon signal sent from the Gateways to the Tags is then used inform the Gateways as to whether the Tags are proximate to the Gateway, as an example, whether they are inside a warehouse. The Beacon signal enables the Tags to broadcast their data payload (data packets). If Tags are able to receive a Gateway beacon signal, then they are relatively proximate to the Gateway, as an example, they are in the same warehouse as the Gateway. Once a beacon signal is received, Tags may start broadcasting their payload of data (data packets). If the Tags are not able to receive the Gateway beacon signal, then they are not proximate to the Gateway, meaning, for example, that they are outside the warehouse or not on site. In this case the Tags do not broadcast a data payload (data packets).

In another embodiment, information may be unicast or multicast by the Tags and Gateways. The particular configuration will depend on the requirements of the system being implemented. In this embodiment, information will still be transmitted “unidirectionally” in the sense that there is no requirement for handshake or request/response communication between the Tags and the Gateways.

The communication protocol utilized by the system is media independent and may be implemented within a wired or wireless system. For a wireless system, the protocol may be implemented on a standard radio frequency band centred at 2.4 GHz or 5 GHz, but may also be implemented on any other suitable radio frequency band. Although the description primarily discloses an embodiment of the invention that utilizes a digital transmission of packets, the protocol is mode independent and other transmission modes may be used, such as analog transmission.

As described above, in one embodiment of the present invention, Gateways are configured to broadcast beacon signals to a plurality of Tags. In one embodiment, beacon signals are sent at random intervals. The Gateways are further configured to receive data packets from Tags. In this manner, the Gateways are capable of receiving packets from the Tags, for example, for tracking purposes. As noted above, in one embodiment, the Gateways are able to determine whether the inventory, to which a Tag is attached, is proximate to the broadcasting Gateway.

In one embodiment of the present invention, Tags are configured to “sleep” for random periods of time. This “sleep” mode is a mode wherein most processes running within the Tag are shut down and the only requirement is a timer to trigger the Tag to “wake” at a random time. Configuring the Tags to sleep allows for battery power to be saved. The amount of time that a Tag sleeps for is configured depending on the requirements of the system.

When the internal timer triggers, the Tag “wakes” and utilizes full power. Upon waking the Tag is configured to momentarily listen for a beacon signal from a Gateway. If no beacon signal is received during the waking period, the Tag goes back into sleep mode for another randomized period of time. However, if a beacon signal is received, the Tag is configured to transmit a message in response. The message is packetized and broadcast or otherwise transmitted back to the Gateways. In one embodiment, a frequency on which the transmission takes place is chosen randomly from a set of frequencies. In this embodiment, the packets are transmitted on the randomly chosen frequency. Randomizing when each Tag wakes up and randomizing the frequency across which packets are transmitted reduces the chances that a collision with other transmissions from other Tags or other Gateways.

The process of the invention is continuous and allows messages from all Tags to be eventually be received by one or more Gateways within a predetermined time period. The amount of time needed for communications from all Tags to be received by one or more Gateways will depend on the specific configuration of the system.

In one embodiment of the present invention provided is a method of communication between at least one remote device and at least one central device. The method comprises determining at the at least one remote device a random amount of sleep time and causing the at least one remote device to enter a sleep mode for the random amount of sleep time. The at least one remote device is then caused to enter a power-on mode after the random amount period of sleep time has elapsed. The at least one remote device is then caused to listen, while in the power-on mode, to identify whether a beacon message was sent from at least one central device. Upon detecting at the at least one remote device a beacon message from the at least one central device, the at least one remote device is caused to transmit a response message and to return to sleep mode. Upon failing to detect at the at least one remote device the beacon message from the at least one central device, causing the at least one remote device to return to the sleep mode.

In a further embodiment of the present invention provided is a method of communication between a central device and a plurality of remote devices. The method comprises causing the central device to wait a random amount of time and causing the central device to transmit a beacon signal to the plurality of remote devices. The central device is then caused to receive a response message from at least one of the plurality of remote devices. At a randomized interval and on a randomized frequency the central device is caused to selected from a number of frequencies to which the central device may tune. Upon receiving a signal from a remote device, the central device is caused to process the data from within the signal.

In a further embodiment of the present invention provided is a system for communications between a plurality of remote devices and at least one central device, comprising at least one central device configured to periodically transmit beacon messages; receive response messages from the plurality of remote devices; process data from the received messages. Provided also are a plurality of remote devices having receivers, each configured to: enter a sleep mode for a random period of time; power-on the receiver after the random period of time has elapsed; listen for a predetermined period of time to detect receipt of a beacon message; upon receipt of the beacon message, transmit a response message and return to sleep mode; upon expiry of the predetermined period of time, return to sleep mode.

In a further embodiment of the present invention the at least one remote device, upon failing to detect the beacon message from the at least one central device, transmits a response message before returning to sleep mode.

In a further embodiment of the present invention the at least one remote device randomly selects a frequency on which to transmit its response message.

In a further embodiment of the present invention the steps repeated until each of the at least one remote devices have successfully transmitted a response message to one of the at least one central devices.

In a further embodiment of the present invention the beacon messages are broadcast.

In an even further embodiment the response messages are broadcast.

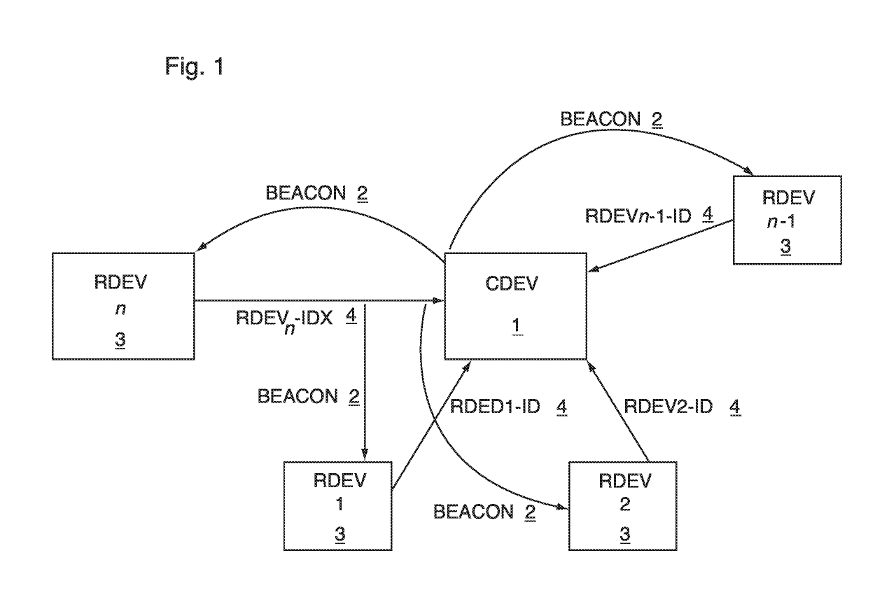

Referring now to FIG. 1, shown is an example consisting of one Gateway (CDEV) 1 and many Tags (RDEVs) 3. The Tags 3 range in number from 1 to n, where n is the maximum number of Tags that may be supported by a Gateway. In one embodiment, a beacon signal 2 is broadcasted from a transmitter (Tx) module present on Gateway 1 at a random rate. The beacon signal that is broadcast by a Gateway enables a receiving Tag to broadcast its payload of data (data packets) back to the Gateway. Due to the random nature of the system, as will be described in further detail below, the system allows for packet collisions during the transmission of data payloads on the assumption that a retransmission at some random future time will be successful. Packet collisions are acceptable for several reasons. First, a packet sent from one Tag may be received by many Gateways at the same time, depending on how the system's topology is implemented. Multiple received packets may then filtered when the data received is processed. Second, it is assumed that the Tag will continue periodically waking up to determine whether it ought to send a transmission in response to a beacon signal. In this way, the system is designed such that even if there is a transmission by a Tag that collides with a transmission from another Tag or Gateway, it will eventually “randomly” wake up to transmit and not collide with another transmission.

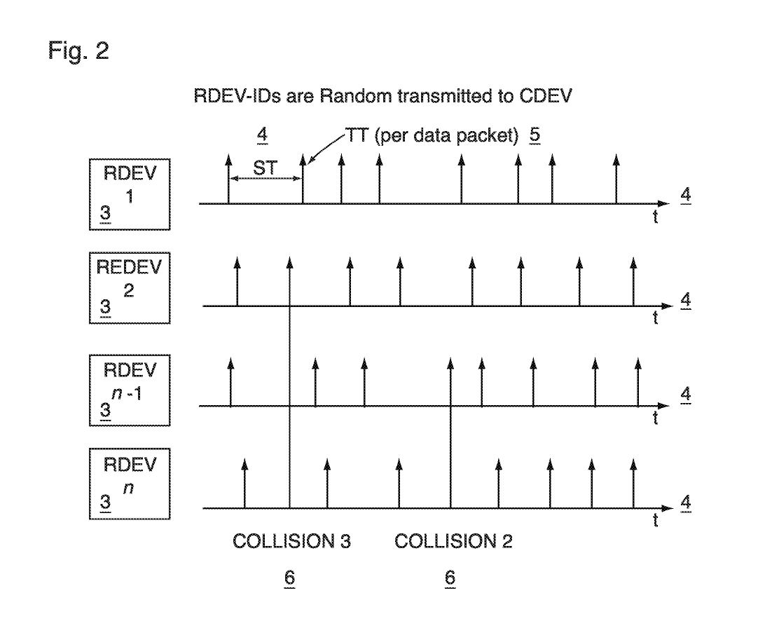

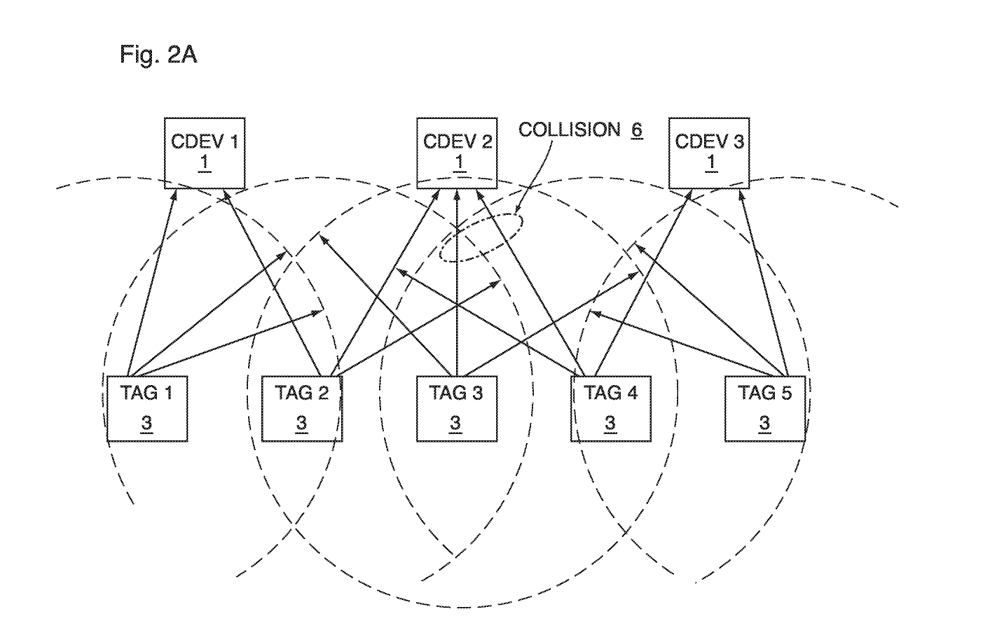

Referring now to FIG. 2, shown is a timing diagram illustrating packet collisions in an embodiment of the current system. Each Tag (RDEV) 3 transmits a data packet to the Gateway (CDEV) 1, on a randomly assigned frequency. If there are only a few frequencies to which a Tag may transmit and if there are a large number of Tags 3 are deployed, there may be a high probability that the same frequency will be selected for transmission by multiple Tags 3. When the same frequencies are selected, and when the transmissions are sent at the same time, collisions 6 occur and packets are lost. However, such packet loss is contemplated and accounted for in the current system as Tags. Specifically, Tags may broadcast their packets multiple times at different times and on different frequencies and, overall, achieve transmission despite the collisions.

Referring now to FIG. 2A, shown are three Gateways (CDEVs) 1 and five Tags 3 (RDEVs). Due to the physical topology and antenna distribution for the example system illustrated in FIG. 2A, every Tag 3 is able to reach one or more of the Gateways with its broadcast signal, but potentially not every Gateway. For example, TAG1 may only reach CDEV1, TAG2 may only reach CDEV1 and CDEV2. The dotted lines illustrate a hypothetical limited range that a Tag's response transmission will reach.

For the example illustrated in FIG. 2A, if data packets transmitted from TAG3 and TAG4 collide 6, the packet transmitted from TAG3 may be lost at this time but the data packet transmitted from TAG4 may be received by CDEV3. In the next time cycle, when TAG3 is powered on and receives a beacon signal, it will broadcast its data packet, at which point the packet may be received by CDEV2.

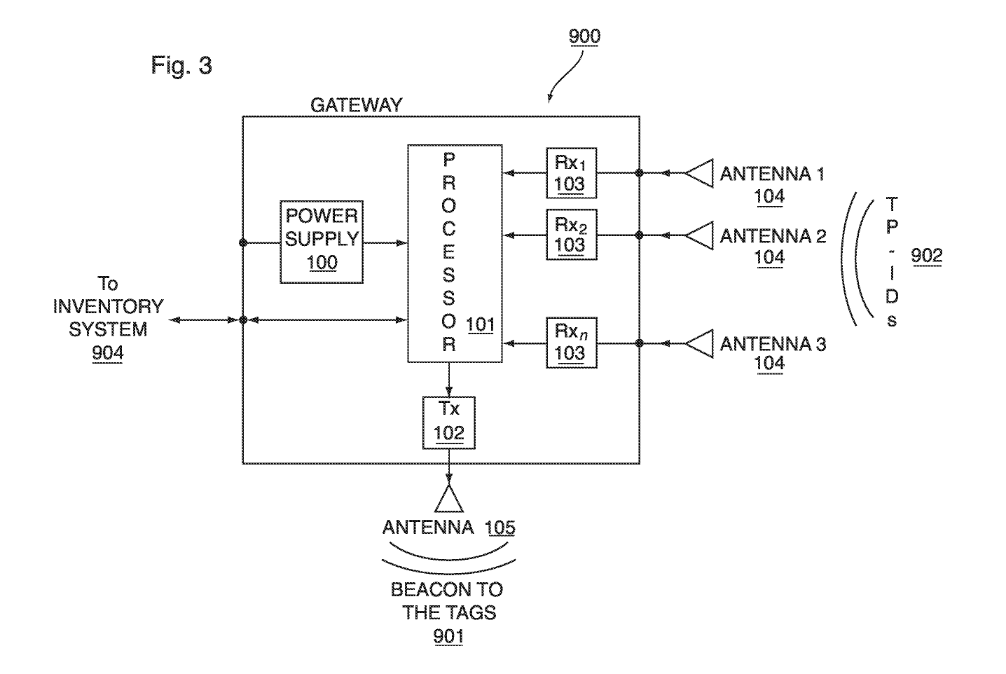

Referring to FIG. 3, shown is one embodiment of a CDEV or Gateway 900 of the present invention. The Gateway is powered by a power supply unit 100, and processes data by way of a processor 101. Using a transmitter (Tx) module 102 and antenna 105 the Gateway is capable of broadcasting a beacon 901 to the Tags. Receiver modules (Rx) 103 are also present on the Gateway and are coupled with antennas 104 to receive data packets that comprise a data payload, which are transmitted from Tags.

Gateway 900 may have more than one receiver (Rx) module comprising more than one tuner. This allows the Gateway 900 to received signals broadcast on multiple channels or frequencies simultaneously. Alternatively, Gateway 900 may include a single receiver module with programming or hardware capable of extracting multiple data streams from one signal. The specific number of receiver modules may be defined for each specific application. The purpose of each receiver module is to listen for incoming transmissions comprising data packets transmitted by Tags. Each receiver module may be tuned to a different frequency channel for receiving data packets that are transmitted at different frequencies. In one embodiment, the frequency at which a given Tag transmits is randomly (or pseudo randomly) selected in order to reduce the likelihood of collisions.

Gateway 900 may be connected to an Inventory System 904. In scenarios where multiple Gateways 900 are used, an Inventory Server 904 receives data from each of the Gateways 900 so that further processing of the data can take place. The Inventory Server 904 may track which Tags have successfully communicated with the Gateways 900 within a predetermined time period to determine whether a Tag is present in the system or not. The predetermined time period is set in accordance with an estimated time in which all Tags present within a particular physical location (e.g., a warehouse) are expected to have successfully transmitted with one or more Gateways 900.

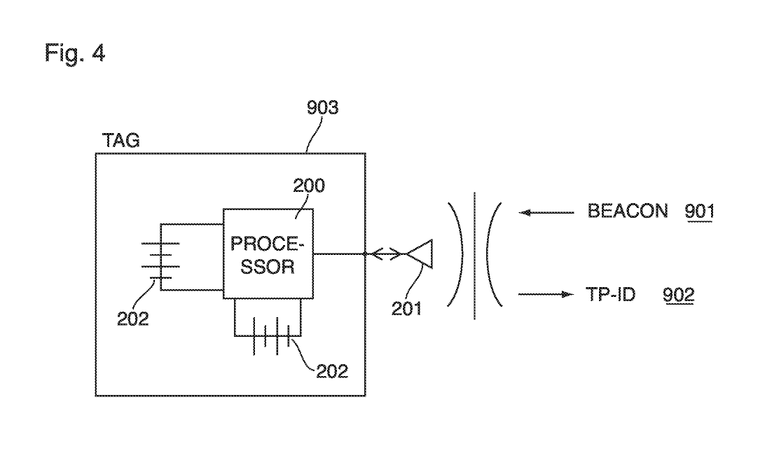

Referring to FIG. 4, shown is one embodiment of a RDEV, or Tag 903, of the present invention. The Tag is powered by batteries 202. Each Tag typically has a transceiver 201, which is configured to receive a beacon signal from a Gateway and broadcast a data payload in the form of data packets back to at least one Gateway. The transceiver 201 is capable of being powered on or powered off. For example, transceiver 201 is powered off when the Tag enters “sleep mode”. Tag 903 comprises a processor for sending commands to power on and power off the transceiver 201. Minimal battery power is needed for processor 200 to maintain a timer and also computer code which determines when the transceiver 201 wakes up.

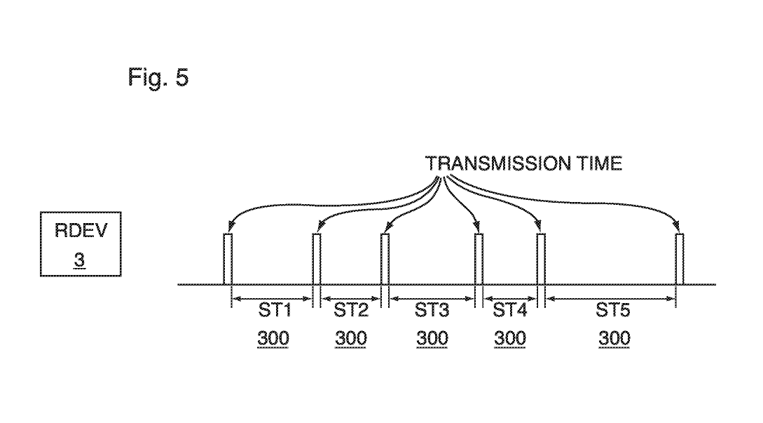

Referring to FIG. 5, depicted is a timing diagram illustrating how the sleep mode works on a particular Tag, showing graphically when the Tag sleeps and when it wakes up (powers on). ST1, ST2, ST3, ST4, and ST5 are the “sleep times” randomly selected by the processor of each Tag. In the embodiment shown, the amount of transmission time is brief relative to the amount of time that the device is in sleep mode.

Certain parameters are used to define, make-up and configure the system, and may be defined as follows:

NTAG [integer] is the number of Tags per Gateway for a specific system configuration. For worst case calculation purposes, this value is taken from the Gateway that has the most number of Tags associated with it.

ST[seconds] is the sleep time in seconds, which is randomly calculated between two values: Sleep Time minimum (STmin) and Sleep Time maximum (STmax), by every Tag on every cycle. The sleep time can vary between 0 and a maximum value.

STmin [seconds] is the minimum Sleep Time allowed for a Tag to sleep.

STmax [seconds] is the maximum Sleep Time allowed for a Tag to sleep.

STavg [seconds] is the average Sleep Time defined for a given implementations of the system and is calculated as:

STavg=(STmin+STmax)/2

STQ [integer] is the quotient of factor between STmax and STavg and is calculated using the equation:

STQ=STmax/STavg

TT[seconds] is the transmission time in seconds and represents the time required for a Tag to broadcast a data packet. Transmission time depends on the available technology.

NDP[integer] is the number of times the same Data Packet is broadcasted every time the TAG wakes up that can be configured for any Tag ecosystem. The NDP selection depends on the specific ecosystem requirements and takes into account certain systemic variables such as noise in the environment where the system is deployed, interference amongst signals, or a signal bouncing among other signals.

NRX[integer] is the number of Rx modules, or channels, that are available to each Gateway and with which the Gateway may randomly receiving a broadcast data payload or data packet from the Tags.

TAGQ [integer] is a quotient or factor between the number of Tags per Gateway and the Sleep Time maximum value for a given system. This parameter is calculated using the following equation:

TAGQ=NTAG/STmax

DPCOL [percentage] is the percentage of broadcast data payloads or data packet lost or not received by the Gateway. It can be calculated using the following equation:

DPCOL=DPLOST/DP TOTAL

### Where:

DPLOST is the total amount of collided data packets broadcast by the NTAG.

DP TOTAL is the total amount of data packets sent by the NTAG.

A simulation of a system may be constructed by a skilled person to evaluate the parameters of the system that are suitable to a particular ecosystem that will be deployed. The simulation may be constructed using computational software or may be made up of computer readable code which may be executed on a computing device.

The first step in defining such a simulation is to define the above listed parameters within the simulation. Namely, the parameters to be defined are: NTAG, STmax, STmin, TT, NDP, NRX. The purpose of the simulation is to calculate parameters values for STQ, TAGQ and DPCOL.

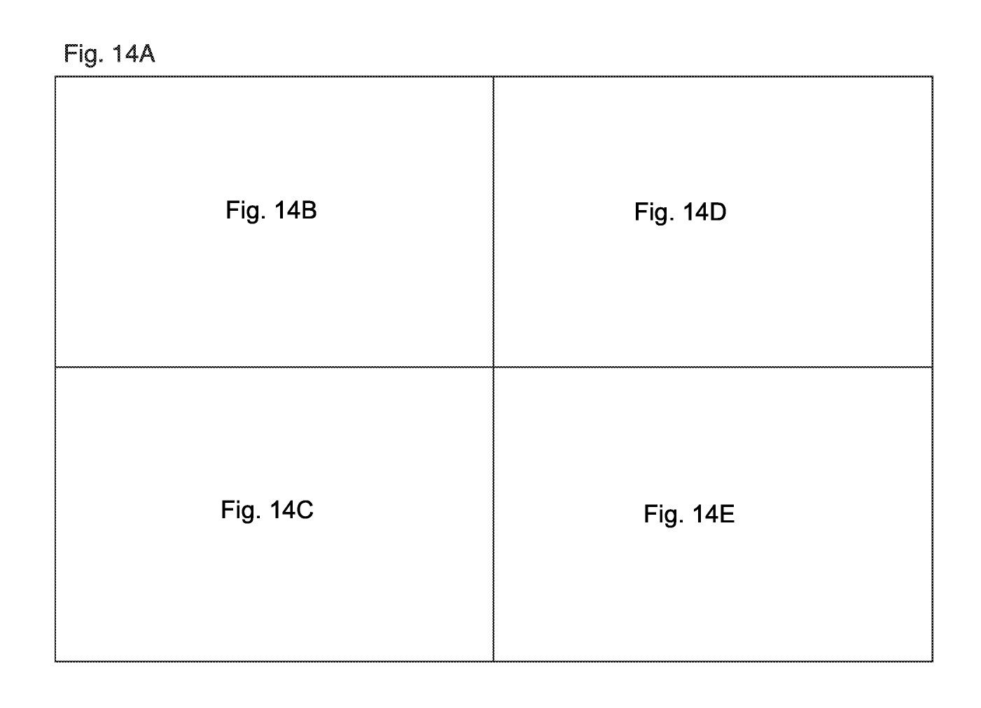

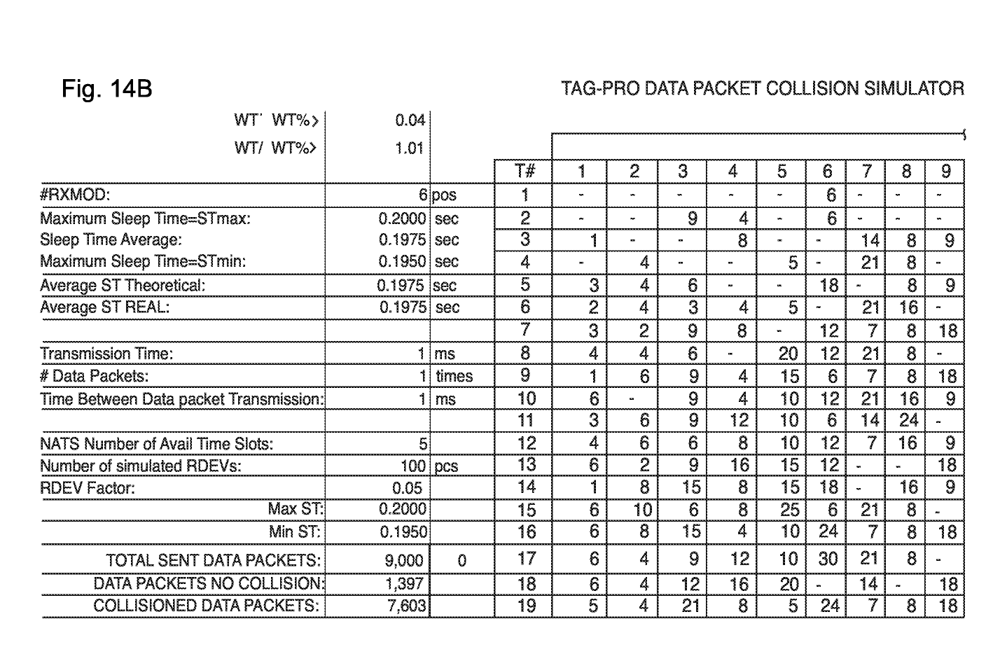

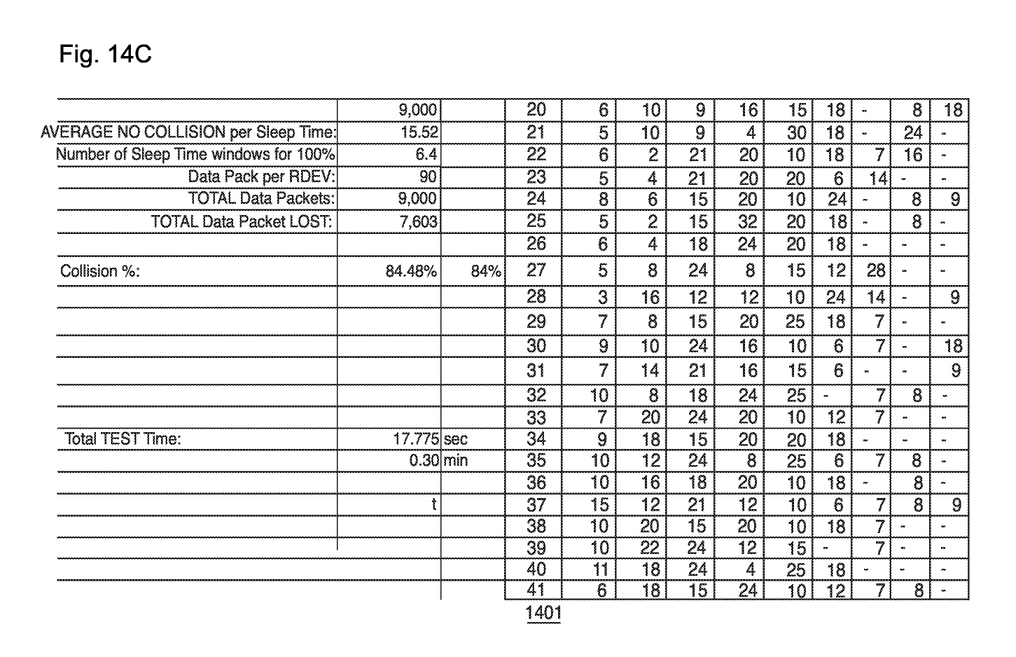

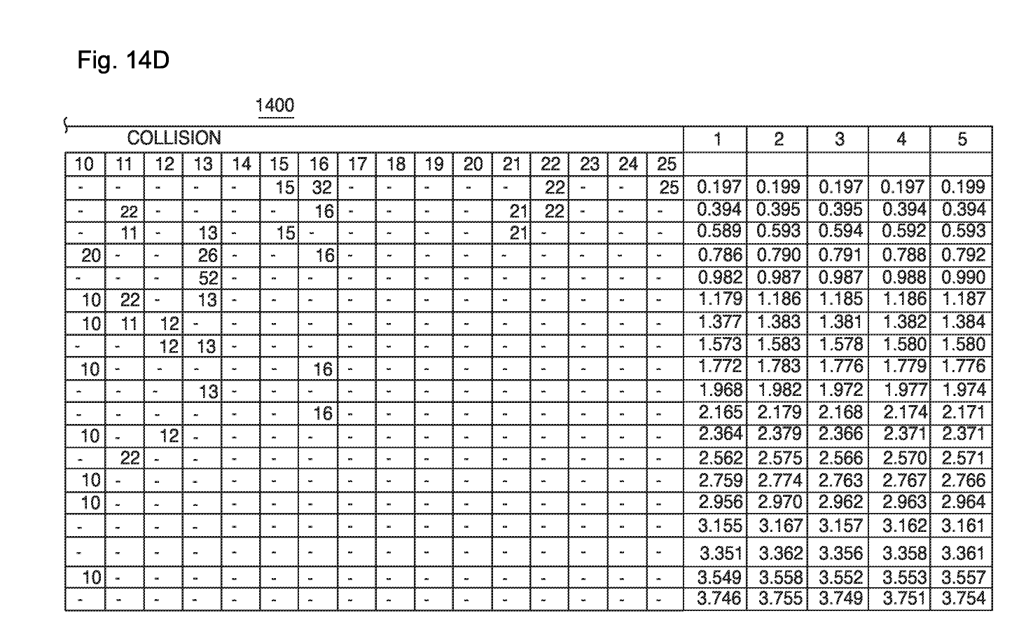

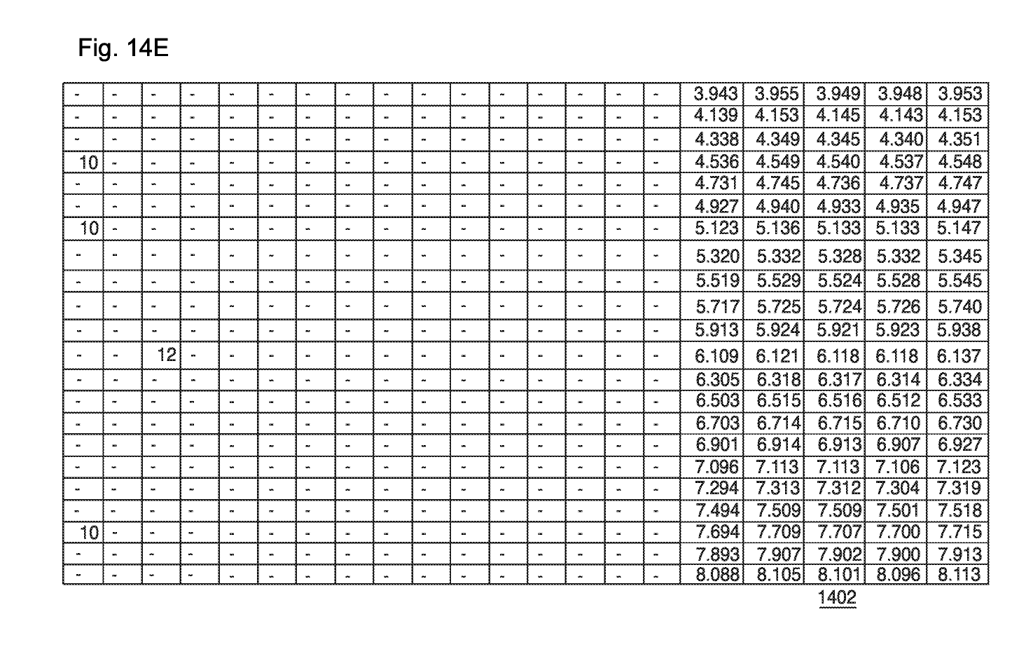

For example, a mathematical simulation may be created to emulate any potential system with any amount of Gateways and any amount of Tags. As explained below, an example simulation was carried out to emulate a system with 100 Tags and 1 Gateway. A screen shot of the simulation may be found in FIGS. 14A-E.

NTAG was set to 100 to represent 100 Tags associated with 1 Gateway. However, a similar simulation may be carried out on any number of Tags and Gateways.

In the example simulation, each Tag was set to transmit its data packet once and NDP was set to be 1. A higher value may also be chosen for NDP, which can be used to simulate multiple packet transmissions.

STmax was set for five different scenarios using: 0.2 seconds, 0.5 seconds, 1 second, 3 seconds and 6 seconds, respectively. The simulation in FIGS. 14A-E shows the simulation being carried out with STmax set to 0.2 seconds to begin with.

STmin was set to different values to determine system behavior.

TT was set to 1 millisecond given standard technology available.

The simulation was run for 150 sleep time windows 1401 for each Tag. The first 41 such sleep time windows can be seen in FIGS. 14A-E. The skilled person will understand that the simulation for the first 41 shown is the same as for the next 150 or for any number of windows. Each one of the 150 sleep times for each Tag was randomized as between a maximum sleep time amount and a minimum sleep time amount. As would be understood by the skilled person, the number of sleep time windows can be adjusted up or down depending on the amount of Tags and Gateways present in an ecosystem to determine when each Tag has successfully transmitted to at least one Gateway.

The wake time for each Tag may be calculated using the random sleep time obtained added to the total sleep time accumulated. In one embodiment, sleep time windows (i.e., the window created between the maximum sleep time and minimum sleep time) can also be truncated, for example to 1 ms, so as to better analyze packet collisions.

The simulation can then be set to determine when any two or more Tags were awake 1402 at the same time based on the simulated sleep window. This situation is intended to simulate when a “collision” occurs. That is, when two Tags are awake, hear a beacon message, and both attempt to send a message in response. As can be seen in the first row of FIGS. 14A-E, the simulated first wake time for Tag 1 was 0.197, for Tag 2 it was 0.199 for Tag 3 it was 0.197, and so on. The simulation then counts the amount of Tags that have the same calculated wake time. In this case a collision would theoretically have occurred between, at least, Tag 1 and Tag 3.

In the example, with 100 Tags and 150 sleep time windows and one packet sent per tag, present are 15,000 individual wake time windows. Every wake time for every Tag may be compared across all 15,000 wake time windows and theoretical packet transmission collisions can be counted.

The simulation may eliminate the first 30 wake times (greyed out in FIGS. 14A-D) for each Tag from the calculations to avoid transient effects on the simulation. Therefore, the total amount of wake times for the simulation to count may be reduced to 9,000.

A collision matrix 1400 can be created to sum the total number of collisions between Tag transmissions. In this manner, data packet collisions were calculated as the sum of collisions in the collision matrix 1400. As a percentage, data packet collisions were calculated based on collided data packets divided by the total packets sent.

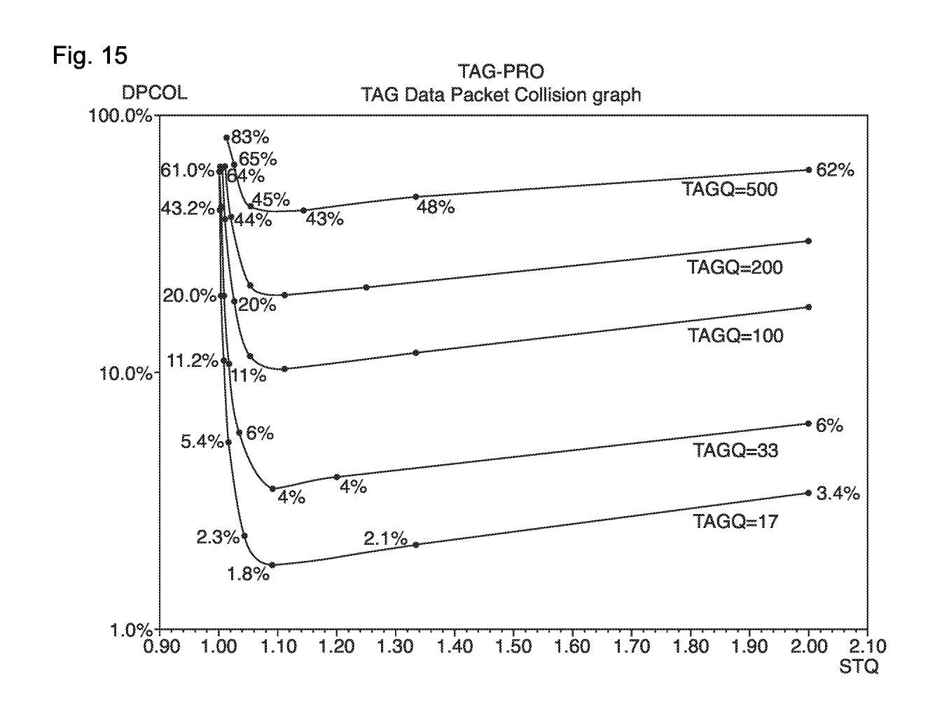

TAGQ, STQ and DPCOL where obtained empirically be running the simulation multiple times using different parameter values, and the results were graphed as depicted in FIG. 15.

As shown in FIG. 15, the data payload or data packet collision rate increase as TAGQ increases. The graphs also shows the that the lower or optimal Tag payload of data or data packet collision, for a given TAGQ, occurs when STQ is on the range of 1.06 and 1.20.

The simulation provides information as to when each of the Tags have successfully transmitted to at least one Gateway. Each time the simulation is run with the same parameters, the time required for all Tags to successfully transmit will vary around a mean value. The person skilled in the art will appreciate that when a sufficient number of simulations are run, the maximum amount of time needed for all Tags to successfully transmit to a Gateway may be approximated by taking the longest time observed in the simulations. In this way, by using the parameters from the simulations in a live system, the Inventory Server in the live system may be programmed to determine that if a Tag has not successfully transmitted to a Gateway within a predetermined time period (i.e., a value slightly greater than the longest time observed in the simulations), the Tag is either no longer transmitting, or is no longer in range of a Gateway.

The communication protocol of the present invention allows for each Tag to successfully to transmit its payload to at least one Gateway over a predefined period of time, for a given system. Simulations may be run to determine how to vary the parameters to ensure that all Tags successfully transmit its payload within the predefined period of time.

TDT is the average Tag Detection Time for a specific TAG PRO system. TDT is obtained empirically and can be measured according to the following formula:

TDT=KTR×STₘₐₓ

KTR is empirically calculated from mathematic simulations or from real systems embodiments.

Further system examples may be built based on the results obtained above. Specifically:

### For Low “Density” System Having:

DPCOL under 5% (from the graph in FIG. 15)

STQ about 1.1 (from the graph in FIG. 15)

TAGQ about 35 (from the graph in FIG. 15)

a KTR=2 to 3 can be expected.

In this situation, and using for example STmax=300 seconds (5 minutes), the following parameter values are to be expected:

NTAG=10,500 Tags per Gateway maximum

TDT between 10 to 15 minutes

### For a “Medium” to “High” Density System Having:

DPCOL under 20% (from the graph in FIG. 15)

STQ about 1.1 (from the graph in FIG. 15)

TAGQ about 100 (from the graph in FIG. 15)

a KTR=6 to 7 can be expected.

In this situation, and using for example STmax=300 seconds (5 minutes), the following parameter values are to be expected

NTAG=30,000 Tags per Gateway

TDT between 30 to 35 minutes.

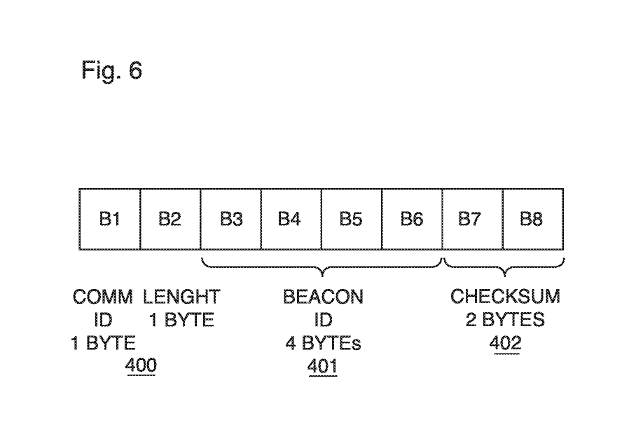

Referring now to FIG. 6, shown is an illustration of an exemplary packet structure for a beacon signal for an embodiment of the present invention. The packet includes a predetermined prefix 400, which may be encoded on 2 or more bytes (B1 and B2). This prefix may also contain functional parameters, configuration parameters, and/or other information. Examples of such parameters or information include: what range of channels a Tag 903 may broadcast its Data Packets, sleep time min and max and other parameters useful for all the Tags. The person skilled in the art will appreciate that other parameters or information may be provided in the beacon signal 901 depending on the requirements of the particular application.

Following the predetermined information 400, the packet may comprise specific beacon identification 401 information encoded, for example, in 4 bytes. This is used to provided identification information as to which beacon sent the information. This identification information may be used by tags to unicast or multicast transmissions back to back to the Gateway which originated the beacon. However, this is not required and in some embodiments, transmission from tags are broadcast to any device in range. Finally the beacon packet ends with a checksum 402 for error correction, which may be encoded on 2 bytes. However, it will be apparent to the skilled person that other packet configurations are possible.

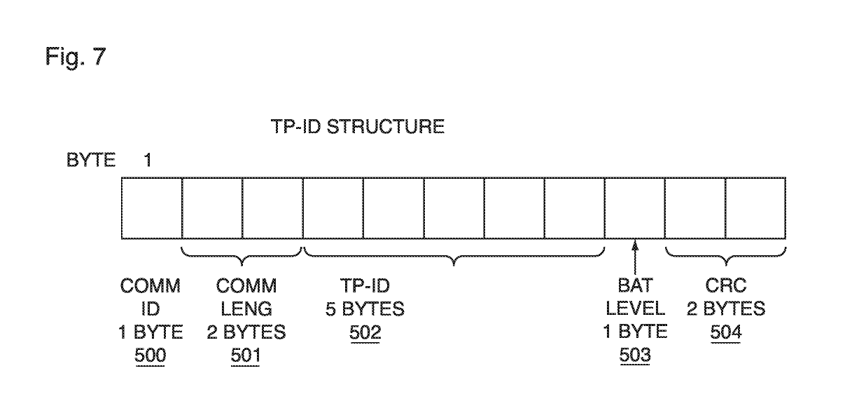

Referring to FIG. 7, shown is an illustration of an exemplary structure of a packet for a remote device or Tag ID, which may be sent by a Tag in an embodiment of the present invention. The packet structure begins with a communication ID 500 byte and a number of bytes indicating the length of the packet. After the communication ID 500 and communication length 501 comes the TP-ID 502, which is specific and unique to each Tag. The TP-ID is the information that allows the Gateway to keep a track of Tag status and whether the Tag is within range of a particular Gateway.

Following the TP-ID is a byte which encodes the battery level 503 of the specific broadcasting tag and a cyclic redundancy check 504, for error checking. The byte for tracking battery level 503 may be processed by a Gateway or an Inventory Server to alert the system that the battery on a Tag may need to be recharged or replaced. It will be apparent to the skilled person that this packet structure is exemplary and may be modified without departing form the scope of the present invention.

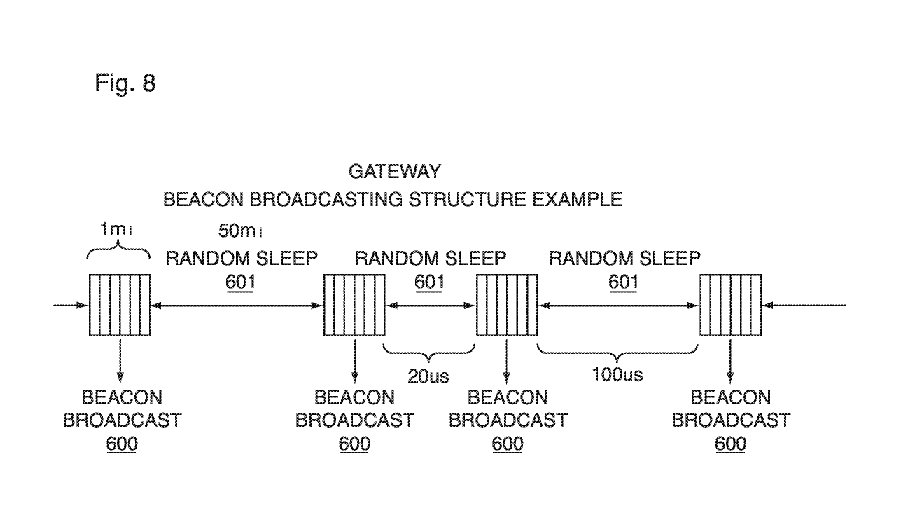

Referring to FIG. 8, shown is an illustration depicting a transmission sequence from the perspective of the gateway. The beacon broadcast 600 is broadcast for a predetermined interval, which is required to transmit a beacon packet. In one example the time required to transmit the beacon broadcast 600 may be 1 ms. However, this time may vary depending on the technology available, the frequencies used, and the amount of information included in the beacon broadcast 600. The broadcast may then stop for a random amount of wait time 601. In this example, the wait time can range from 50 to 200 milliseconds. After the wait time, the beacon signal is again broadcast. The cycle repeats indefinitely. In this example the beacon is broadcast, but the beacon signal may also be transmitted via unicast or multicast.

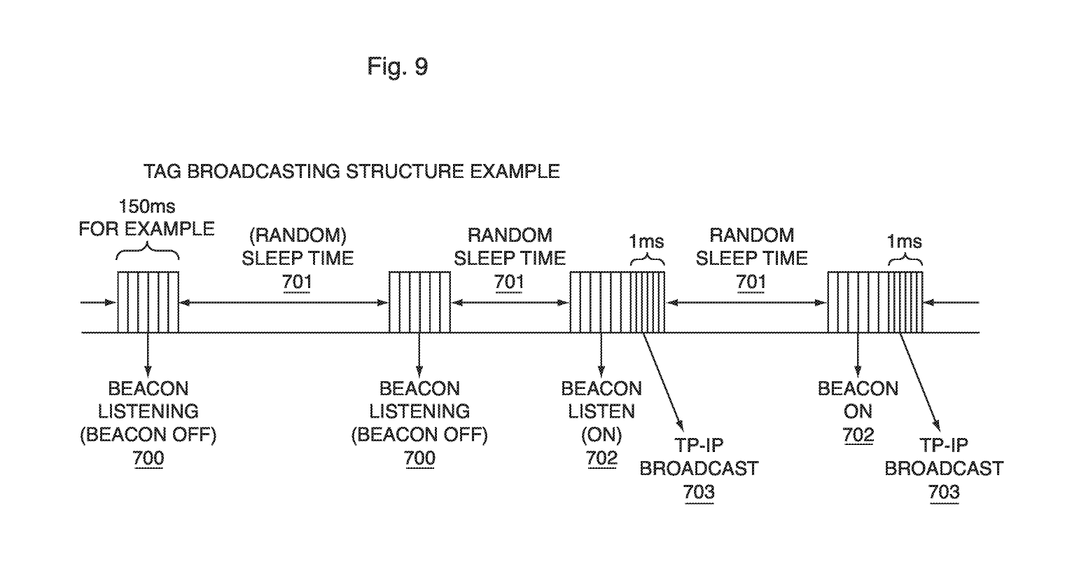

Referring to FIG. 9, shown is an illustration of a transmission sequence from the perspective of a Tag. FIG. 9 illustrates the overlap between the beacon broadcast and the Tag packet broadcast. In the illustrated example, a Tag is configured to “sleep” for a random period of time 701. After the random period of time elapses, the Tag is configured to “wake” up, or power on. Once powered on, a Tag will listen for a beacon signal for a predetermined period of time 700. In this example, a Tag may potentially listen for 150 ms, after which a time out is triggered in the case that a beacon signal is not present, or a beacon signal is received. If no beacon signal is received in the randomized 150 ms listening window, the Tag will re-enter “sleep” mode 701 for another random length of time. After sleep mode the tag “wakes” up again and listens. If a beacon signal is received when a Tag is in a listening window, the Tag is configured to broadcast information to the available Gateways in its neighbourhood of proximity. All the available Gateways proximate to a Tag will receive that Tag's broadcasted Tag data packet and TP-ID. Prior to broadcasting, the Tag randomly chooses a frequency on which to broadcast its data. This frequency is chosen from those available to the receiving modules at the Gateway. In this example the Tag broadcasts it's response message. However, the response message may also be transmitted via unicast or multicast.

In a further embodiment, a Tag 903 may or may not broadcast its data to the Gateways depending on the information contained in the beacon signal 901. For example, beacon signal 901 may be unicast to a single tag or multicast to a subset of all tags that are intended to receive the message. Only those Tags to which the beacon signal 901 is sent respond to that message.

In another embodiment, the beacon signal 901 is sent from the Gateway 900 to let the Tags 903 know that they are “close” or “in range” such that data packets may be sent by the Tags 903 to the Gateway 900.

The data sent by a Tag on a specific and randomly chosen frequency is received by the receiver module on a Gateway 900 that is tuned to that frequency. The received Tag packet may be processed, filtered, and analyzed by the Gateway 900. Data received by the Gateway may further be stored, retransmitted, and/or analyzed. Other processes or processing may also be carried out on the data by a Gateway 900 as required in a specific implementation of the communication protocol. Also, the data received by the Gateway 900 may be retransmitted to an Inventory Server for further processing.

In this manner, the Gateway may randomly collect data on Tags deployed on inventory. The cycle of the Tag “sleeping” for a random amount of time 701 and “waking up” to listen the beacon signal 700 continues indefinitely, and even if the TDT for a particular system is reached and 100% transmission has occurred. TDT is defined as the maximum time for all the Gateways installed on a specific system to receive a specific TP-ID, from the time when the TAG goes into the warehouse and it is “in range” of the Beacon signal.

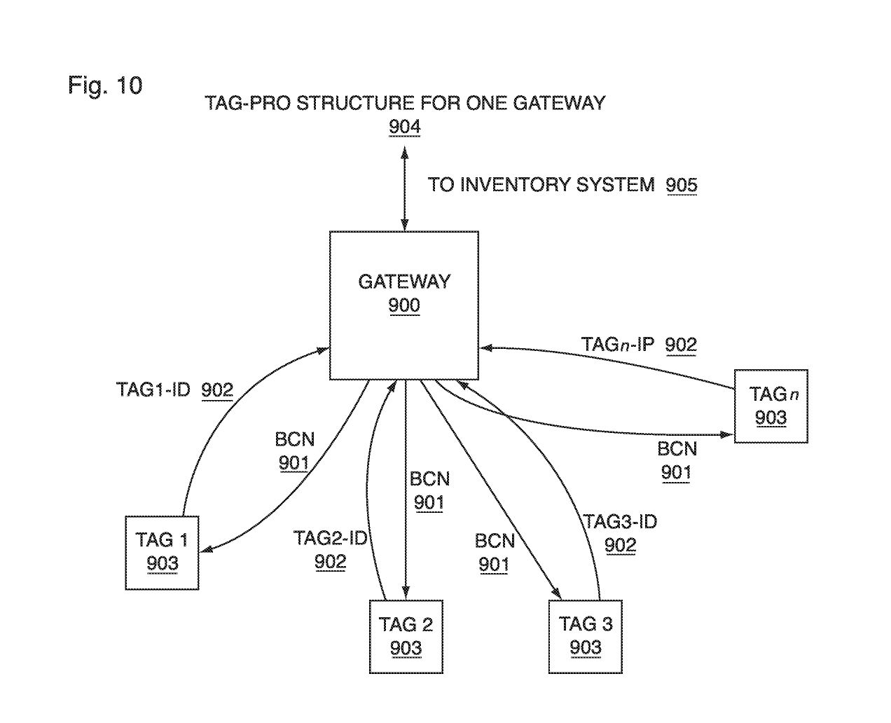

Referring to FIG. 10, shown is a schematic diagram of a system employing one central device and multiple remote devices, or tags. The central device, or Gateway 900, sends out a beacon 901 in a manner similar to FIG. 8. As soon as the Tags are “listening” for a beacon signal they are enabled to broadcast their TP-ID containing data packets to the Gateway on a randomize broadcast frequency. Data received at the Gateway 900 may then sent from the Gateway 900 to an inventory system 904.

In a further embodiment of the present invention, each Gateway 900 may also be enabled to communicate by way of the communications network 905 according to any suitable protocol compatible with an inventory system 904. Further, each Gateway 900 may be enabled to communicate in a wireless or wired manner, as may be required in a certain application, compatible with the communications network 905, including but not limited to packet based communication protocols, Internet protocols, analog protocols, PSTN protocols, cellular protocols, WiFi protocols, WiMax protocols and any combination of protocols. Other protocols may also be used.

Communications network 905 may also comprise a combination of wired or wireless networks, including but not limited to packet based networks, the Internet, analog networks, PSTN, LAN, WAN, cell phone networks, WiFi networks, WiMax networks and any combination of networks.

By way of the communications network 905, each Gateway may communicate the status of each Tag to the inventory system 904 to keep track of the location and status of inventory. Alternatively, the Gateway may transmit the received Tag messages to the inventory system 904 for further processing. In this scenario, the inventory system 904 would process the received Tag messages to determine the location and status of inventory.

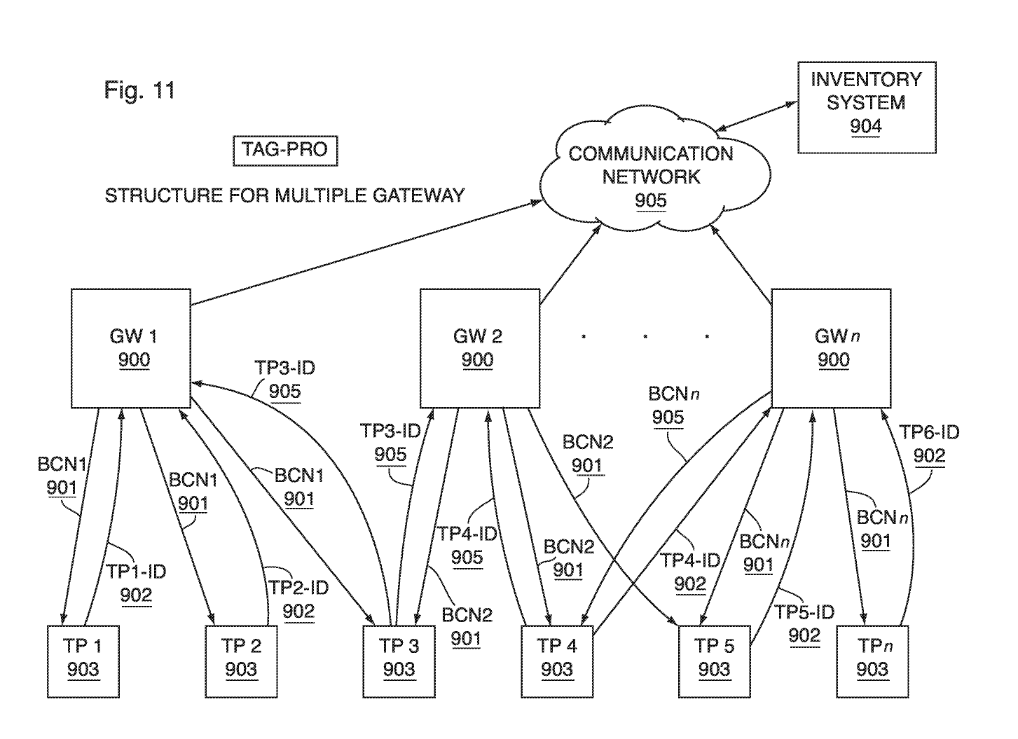

Referring to FIG. 11, shown is a schematic diagram of a system employing multiple central devices and multiple remote devices. In this example, three Gateways 900 broadcast beacon signals out in the manner similar to FIG. 8. If the Tags 903 are “awake” and they are able to “listen” for a broadcast beacon signal, they can then broadcast their TP-ID containing data packets to the Gateways. In some situations, a Tag 903 receives, beacon signals 901 from multiple gateways 900, and if the Tags 903 are in the “awake” mode, a TP-ID 905 is broadcast to all the Gateways 900. Each Gateway 900 then transmits information about the Tags from which they have received messages to the Inventory System 904 via a communication network.

The Inventory System 904 may comprise a computer-based system for tracking inventory levels, orders, sales, deliveries, and any other information that the skilled person could require. In this manner, the Inventory System 904 may facilitate the tracking of inventory or assets as they move through a warehouse or storage depot. The system may produce a directory of inventory assets to provide information on exactly what is available and where.

In a further embodiment of the present invention, packet collisions may be further mitigated if Tags are also configured to randomly send data back to the gateway more than once during a predetermined waking period, when a beacon signal has been received.

One feature of the communication protocol is that there is no requirement to synchronize the beacon signal from the Gateways to the Tags or to synchronize data packets from Tags to Gateways. In particular, there is no need to synchronize timing to avoid signal collisions. Instead, signals are broadcasted by Gateway to Tags and vice versa based on random “sleep” timing and a randomly selected frequency channel, and is intended to be transmitted (or broadcast) more than once. By setting timing parameters and frequency parameters appropriately transmission from Gateway to Tag or from Tag to Gateway may be statistically guaranteed for a given time period.

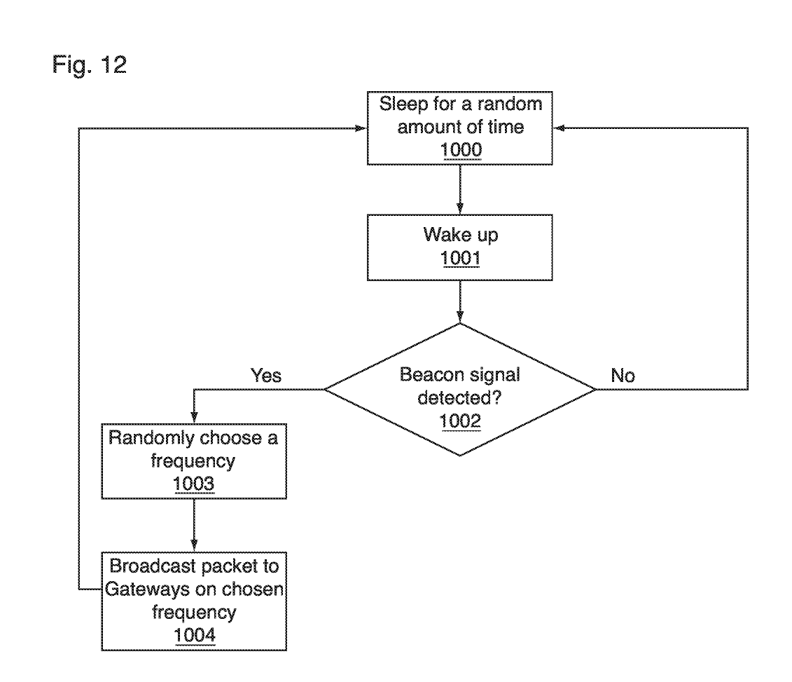

Referring to FIG. 12, shown is an exemplary method for how a Tag communicates with a Gateway or multiple Gateways. The method comprises a first step of causing the Tag to enter a sleep mode for a randomized period of time 1000. After a randomized period of time, Tag is caused to exit sleep mode to enter a power-on or “waking” mode 1001 and further to listen if a beacon signal is broadcast from any proximal Gateway. If a beacon signal has been detected, the Tag is caused to randomly select a frequency 1003 on which to broadcast a data packet 1004 to the available Gateways. Broadcasting the signal to the available Gateways causes the Tag to return to sleep mode 1000 and begin the cycle again. If no beacon signal is received, the tag returns to the sleep mode 1000 and begins the cycle again. In another embodiment of the present invention, Tags may also broadcast their data packets without first received a beacon signal or ever listening for one. In such an embodiment, a Tag may also be programmed to send its data after a predetermined number of times the Tag has entered “wake” mode. For example, a Tag may leave sleep mode and enter wake mode three separate times and never sense a beacon single. In such a case the Tag may be programmed to nevertheless send its data.

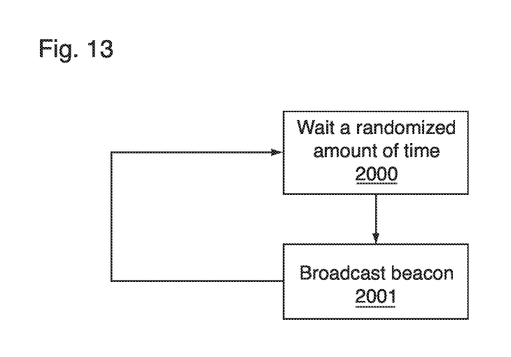

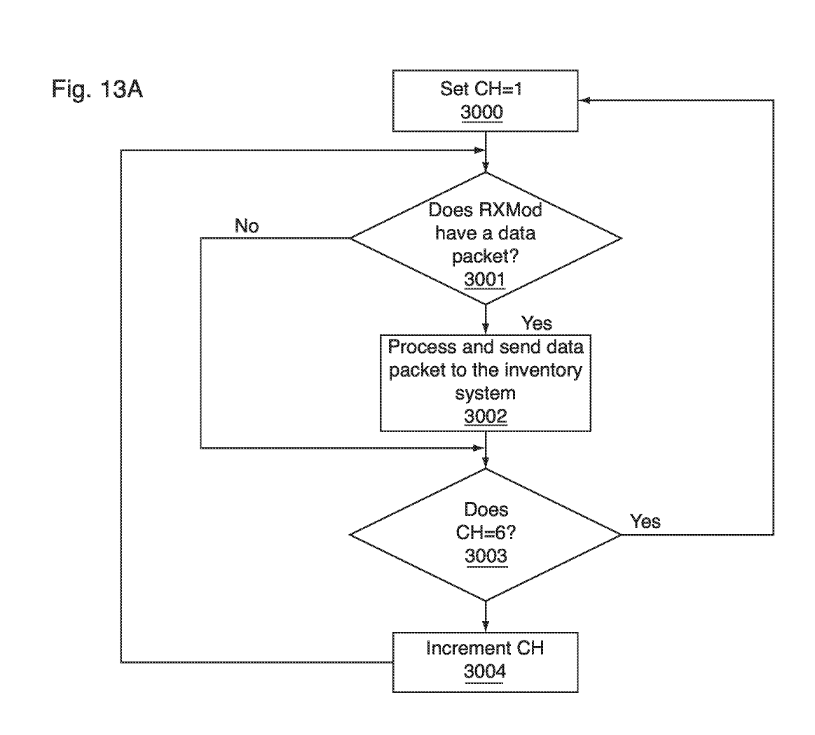

Referring to FIG. 13, shown is an exemplary method of how at least one Gateway broadcasts a beacon signal to one or more deployed Tags. The method, consists of the steps for causing the Gateway to wait a random period of time 2000 and the causing the Gateway to broadcast a beacon signal 2001 to the Tags. This cycle to repeats indefinitely and until the beacon signal is shut down by a system manager for maintenance, testing or other purposes. Alternatively, the beacon signal may be transmitted after a predetermined sleep period which is not random.

Referring to FIG. 13A, shown is an exemplary method of how at least one Gateway with 6 receiver modules determines if it has received data transmitted from at least one Tag. At step 3000, the at least one Gateway sets the channel which it will poll to 1. At step 3001, it is determined whether data has been received by the Rx module tuned to the first channel. If data has been received on the first channel, the Gateway proceeds to step 3002 and processes the data packet that was received on that channel. The information from the processed data packet is then sent to the inventory server and tracking of the corresponding Tag is completed. If no data has been received on the first channel, or if the data on the first channel has been processed, the system moves to step 3003. At step 3003, the Gateway checks if it has polled each of its available channels/receiver modules. In this example, the particular Gateway has 6 channels to poll and so the method checks if all 6 have been polled. If 6 have been polled then the system returns to the first channel and begins the process anew. If 6 channels have not been polled, the Gateway increments, at step 3004, the channel count and checks the Rx module corresponding to the channel count for received data. This cycle continues indefinitely. In an alternative embodiment, the Gateway is capable of monitoring more than one channel. In yet a further embodiment, the Gateway is capable of monitoring all available channels.

Although embodiments of the present invention have been described above and are illustrated in the accompanying drawings in order to be more clearly understood, the above description is made by way of example and is not meant to limit the scope of the present invention. It is contemplated that various modifications apparent to one of ordinary skill in the art could be made without departing from the scope of the invention which is to be determined by the following claims.

1. A method of communication between at least one remote device and at least one central device, the method comprising:
determining at the at least one remote device a random amount of sleep time;
causing the at least one remote device to enter a sleep mode for the random amount of sleep time;
causing the at least one remote device to enter a power-on mode after the random amount period of sleep time has elapsed;
causing the at least one remote device to listen, while in the power-on mode, to identify whether a beacon message was sent from at least one central device;
upon detecting at the at least one remote device a beacon message from the at least one central device, transmitting a response message and causing the at least one remote device to return to sleep mode;
upon failing to detect at the at least one remote device the beacon message from the at least one central device, causing the at least one remote device to return to the sleep mode.

2. The method of claim 1 wherein the at least one remote device, upon failing to detect the beacon message from the at least one central device, transmits the response message before returning to sleep mode.

3. The method of claim 1, wherein the at least one remote device randomly selects a frequency on which to transmit the response message.

4. The method of claim 1, wherein the method is repeated until each of the at least one remote devices have successfully transmitted a response message to one of the at least one central devices.

5. The method of claim 1, wherein the beacon messages are broadcast.

6. The method of claim 1, wherein the response messages are broadcast.

7. A method of communication between a central device and a plurality of remote devices, said method comprising:
causing the central device to wait a random amount of time;
causing the central device to transmit a beacon signal to the plurality of remote devices;
causing the central device to receive a response message from at least one of the plurality of remote devices;
at a randomized interval and on a randomized frequency selected from a number of frequencies to which the central device may tune;
upon receiving a signal from a remote device, causing the central device to process the data from within the signal.

8. The method of claim 7, wherein the response message is transmitted on a randomly selected frequency.

9. The method of claim 7, wherein the method is repeated until each of the plurality of remote devices have successfully transmitted a response message to the central device.

10. The method of claim 7, wherein the beacon message is broadcast.

11. A system for communications between a plurality of remote devices and at least one central device, comprising:
at least one central device configured to:
periodically transmit beacon messages;
receive response messages from the plurality of remote devices;
process data from the received messages; and,
a plurality of remote devices having receivers, each configured to:
enter a sleep mode for a random period of time;
power-on the receiver after the random period of time has elapsed;
listen for a predetermined period of time to detect receipt of a beacon message;
upon receipt of the beacon message, transmit a response message and return to sleep mode;
upon expiry of the predetermined period of time, return to sleep mode.

12. The system of claim 11, wherein the at least one central device transmits beacon messages at random predetermined time intervals.

13. The system of claim 11, wherein the at least one remote device randomly selects a frequency and transmits the response message on that frequency.

14. The system of claim 11, wherein the beacon messages and the response messages are broadcast.

15. The system of claim 11, wherein the at least one remote device, upon determining that no beacon message was received, transmits the response message before returning to sleep mode.
